(19) United States
(12) Patent Application Publication
(10) Pub. No.: US 2008/0245118 A1
(43) Pub. Date: Oct. 9, 2008

(54) Multi-functional burglar-proof lockset assembly structure

(76) Inventor: Chen-Kuei Hsieh, Jhongli City (TW)

Correspondence Address: TROXELL LAW OFFICE PLLC, Suite 1404, 5205 Leesburg Pike, Falls Church, VA, 22041, US

(21) Appl. No.: 11/783,278

(22) Filed: Apr. 6, 2007

(51) Int. Cl. B60R 25/02

(52) U.S. Cl. 70/209; 340/568.1

(57) ABSTRACT

A multi-functional burglar-proof lockset assembly structure is composed at least of a lockset, a burglar-proof alarm circuit, and a communication module. The lockset body can be locked on a steering wheel to restrict rotation, and at a same time when the lockset is locked, the burglar-proof alarm circuit in the lockset, a detection end and a vibration sensor are activated, to detect a possible condition when a car is stolen, such as a change of atmospheric pressure, a movement of object, masking or interruption to an ultrasonic signal, fracturing to a glass, or abnormal vibration. In addition, an output signal is transmitted to a central processing unit for discrimination, and when a burglar-proof alert message is created, the burglar-proof alarm circuit can notify a user the burglar-proof alert message, thereby achieving effects of burglar-proofing with multiple alerts, and ultrasonic signal prevention and detection.

### BACKGROUND OF THE INVENTION

(a) Field of the Invention

The present invention relates to a multi-functional burglar-proof lockset assembly structure, and more particularly to a multi-functional burglar-proof lockset assembly structure which is provided with a burglar-proof alarm circuit that can precisely detect bands in large range.

(b) Description of the Prior Art

Many people are now configuring an electronic burglar-proof device or a mechanical burglar-proof lockset for their cars to secure them without being stolen. However, no matter using what kind of mechanical lockset that is precise, hard to unlock, robust, and hard to damage, or what kind of electronic burglar-proof device that senses precisely and is provided with multiple functions, it can only delay a carnapper to successfully steal the car, due to a brilliant stealing technique of the carnapper. Therefore, a complete burglar-proof effect cannot be truly achieved. As a matter of fact, it is not difficult to unlock or damage the lockset, as long as one has sufficient time and well-prepared equipment. Accordingly, an ideal and effective burglar-proof device should be both provided with the features of a mechanical lockset that is robust and hard to damage, and of a burglar-proof alert device that is precise and sensitive. Furthermore, when a thief is stealing the car, many different frequencies will be formed due to many different actions; therefore, when the electronic burglar-proof device is detecting a change of ambient condition, many sensors for detecting different bands should be used to detect different frequencies, and trigger the burglar-proof device. As functions of radio wave transmission used by an ordinary burglar-proof system are restricted by radio-related rules of each country that transmission power which is too large is not permitted and bandwidths are also restricted; therefore, transmission distance and a range of security are substantially limited, which will seriously affect an in-time annunciation efficiency of the burglar-proof system.

### SUMMARY OF THE INVENTION

The primary object of present invention is to provide a multi-functional burglar-proof lockset assembly structure, especially a structure having a burglar-proof alarm circuit that can precisely detect bands in large range, and an automobile burglar-proof alarm lock which can notify a car owner through a cellular phone communication module in time.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a perspective view of the present invention.

FIG. 2 shows a block diagram of the present invention.

FIG. 3 shows a schematic view of an embodiment of the present invention.

FIG. 4 shows a block diagram of an embodiment of the present invention.

FIG. 5 shows a circuit diagram of the present invention.

FIG. 6 shows a flow diagram of the present invention.

FIG. 7 shows a second flow diagram of the present invention.

### DETAILED DESCRIPTION OF THE PREFERRED EMBODIMENTS

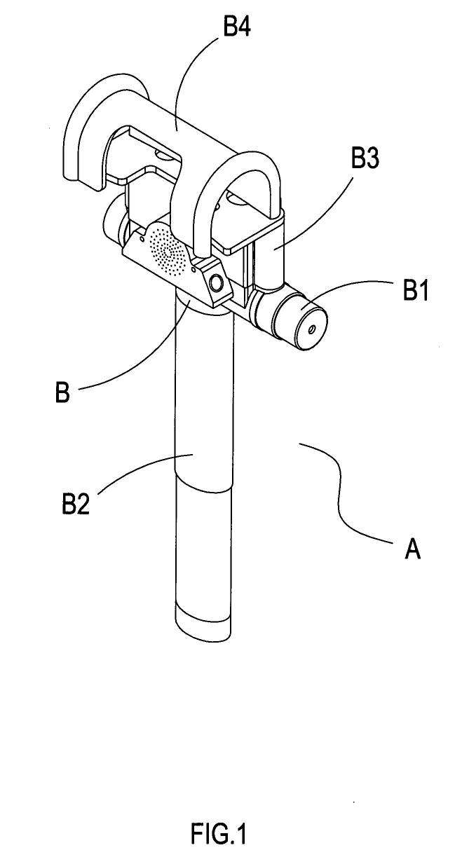

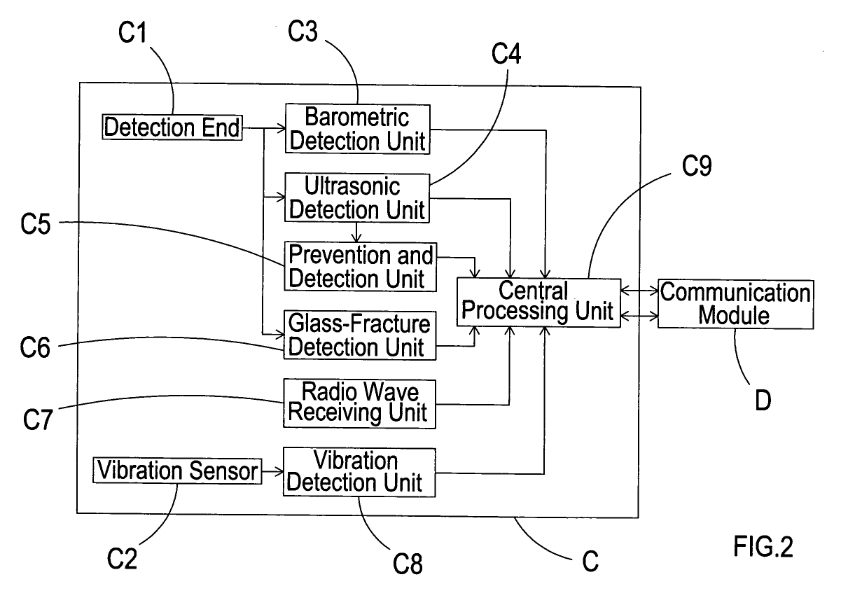

The present invention is to provide a multi-functional burglar-proof lockset assembly structure. Referring to FIG. 1 and FIG. 2, a burglar-proof lockset A is constituted by a lockset B, a burglar-proof alarm circuit C, and a communication module D. The lockset B is provided with a locking body B1 which can be opened or locked, and the locking body B1 is extended with a rod B2 and a locking seat B3. In addition, the locking seat B3 is extended with a locking sheath B4 which can be locked on a steering wheel, and an interior of the locking seat B3 is provided with the burglar-proof alarm circuit C which is extended with a detection end C1 that can detect frequencies in large range. A barometric detection unit C3, an ultrasonic detection unit C4, an ultrasonic signal prevention and detection unit C5, and a glass-fracture detection unit C6 of the burglar-proof alarm circuit C are electrically conducted through the detection end C1. In a mean time, a vibration detection unit C8 and a radio wave receiving unit C7 that receives radio wave signals of the burglar-proof alarm circuit C are electrically conducted through a vibration sensor C2. Furthermore, the signals are transmitted to a central processing unit C9 for discrimination, such that when a burglar-proof alert message is created, the burglar-proof alarm circuit C can dial a preset telephone number through the communication module D to notify a user the burglar-proof alert message, thereby achieving a burglar-proof function with multiple alerts, and a function of prevention and detection.

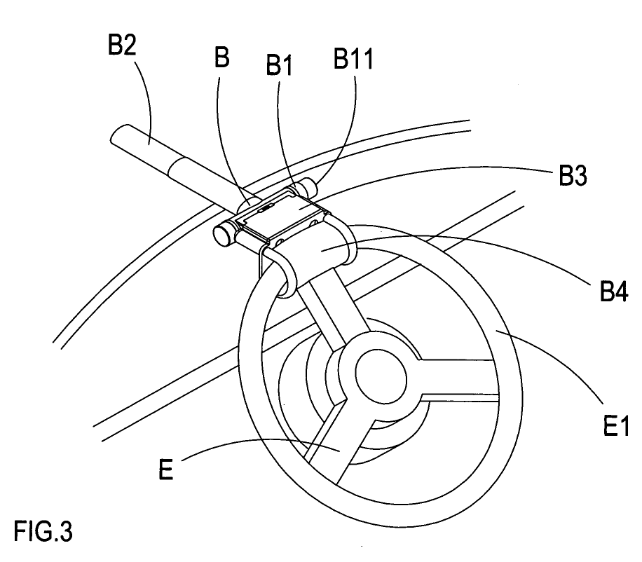

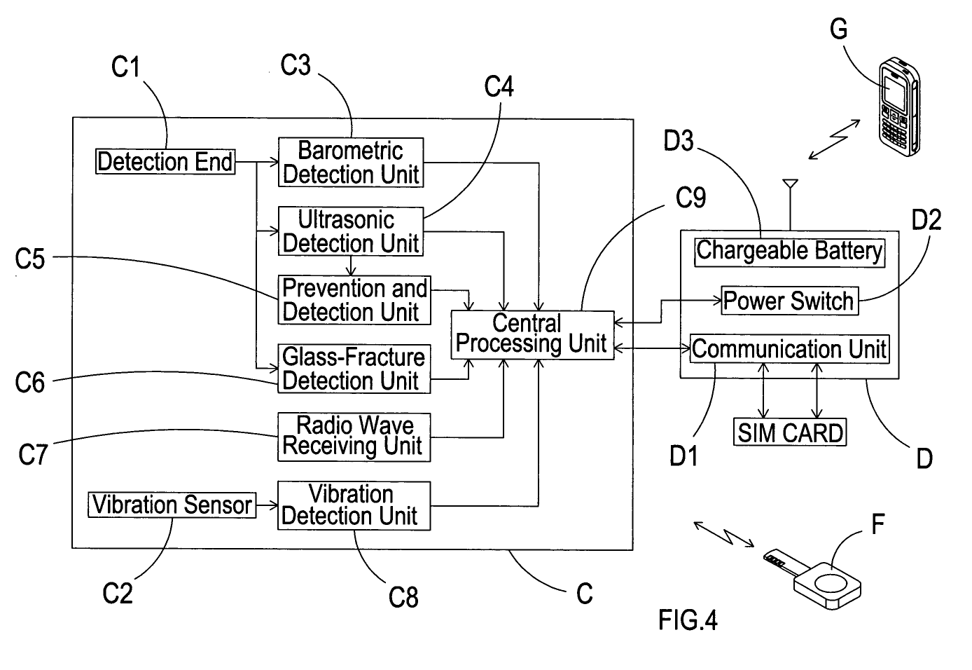

Referring to FIG. 3 and FIG. 4, a lockset B is extended with a locking body B1 which is provided with a lock head B11 that can be opened or locked, and which is extended with a rod B2 and a locking seat B3. In addition, the locking seat B3 is extended with a locking sheath B4 that can be locked on a steering wheel E. Upon locking, the locking sheath B4 is sheathed on a wheel ring A1 of the steering wheel E, and is locked on the locking seat B3; whereas, the rod B2 of lockset B is extended on a driving panel, enabling the lockset B to be locked on the steering wheel E, thereby restricting rotation of the steering wheel E and achieving a purpose of burglar-proofing and securing an automobile. At a same time when the lock tool B is locked, a burglar-proof alarm circuit C inside the lockset B is activated too. If, during a period of burglar-proof operation, the burglar-proof alarm circuit C detects that atmospheric pressure in the car changes momentarily, an object is moving in the car, an ultrasonic signal is masked or interrupted, a glass is fractured, or the car vibrates abnormally, then the burglar-proof alarm circuit C will send out strong burglar-proof alarm sound and intense flash to deter a thief. At a same time, a burglar-proof alarm signal will be driven by the burglar-proof alarm circuit C to dial a preset telephone number to notify a car owner a burglar-proof alert message.

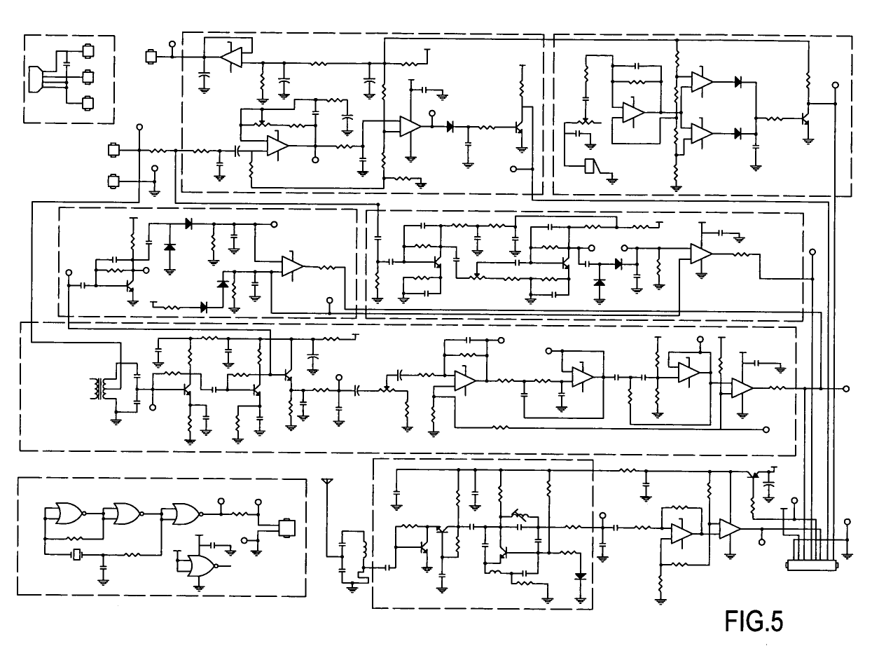

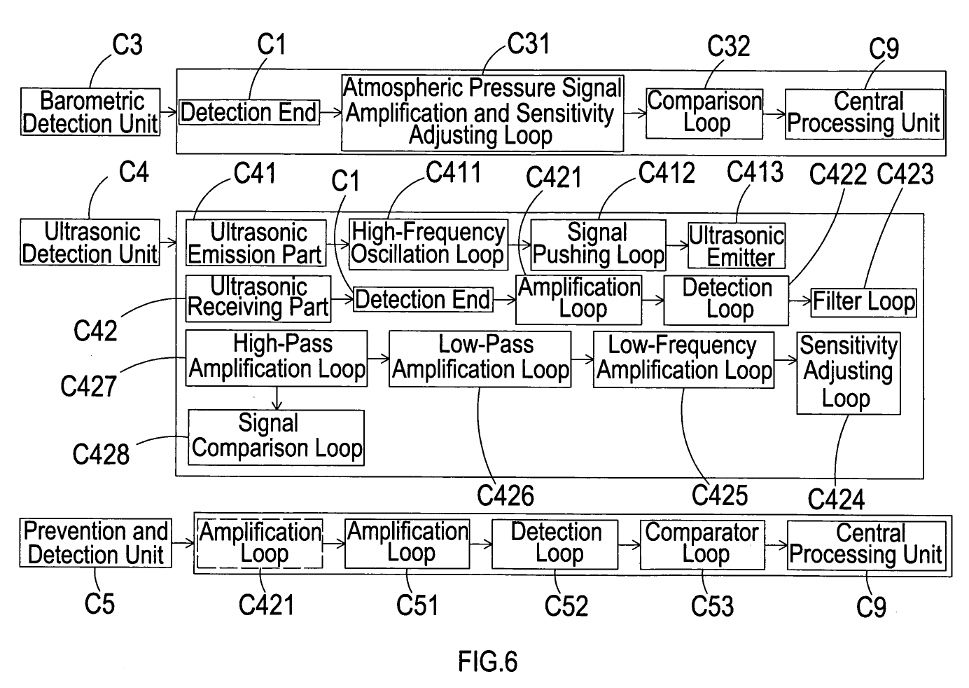

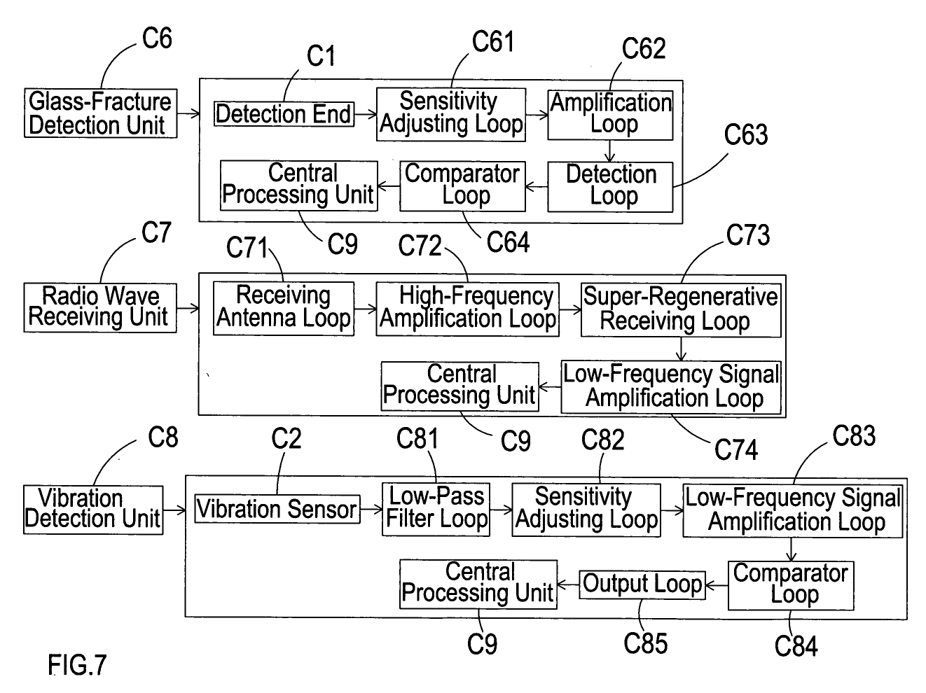

Referring to FIGS. 4 to 7, the detection end C1 of the burglar-proof alarm circuit C is a mechanical capacitor, mechanical piezoelectric, and semi-conductor microphone device, and can detect a change of frequency, such as the change of atmospheric pressure, the movement of an object, the fracturing of a glass, or that the ultrasonic signal is masked or interrupted. In the mean time, the vibration sensor C2 detects whether there is abnormal vibration, so as to facilitate the burglar-proof alarm circuit C to proceed with detection of frequencies in large range. Furthermore, the detection end C1 electrically conducts the barometric detection unit C3, the ultrasonic detection unit C4, the ultrasonic signal prevention and detection unit C5, and the glass-fracture detection unit C6 of the burglar-proof alarm circuit C; whereas, the vibration sensor C2 electrically conducts the vibration detection unit C8.

The barometric detection unit C8 which operates by a signal of change of atmospheric pressure includes an atmospheric pressure signal amplification and sensitivity adjusting loop C31 and a comparison loop C32, wherein a pressure detection loop of the atmospheric pressure amplification and sensitivity adjusting loop C31 can detect a momentary change of air pressure in the car, and transform a monitored message into an electronic signal which is processed by the comparison loop C32 and is then transmitted to the central processing unit C9 for discrimination, thereby effectively detecting the change of atmospheric pressure in the car.

The ultrasonic detection unit C4 which operates by a signal of object movement includes an ultrasonic emission part C41 that sends out an ultrasonic signal to a space in the car, and an ultrasonic receiving part C42 for receiving the signal which is analyzed and processed and is then transmitted to the central processing unit C9 for discrimination. The ultrasonic emission part C41 is provided with a high-frequency oscillation loop C411, a signal pushing loop C412, and an ultrasonic emitter C413; whereas the ultrasonic receiving part C42 is provided with an amplification loop C421 which can amplify a reflection wave signal, a detection loop C422, a filter loop C423, a sensitivity adjusting loop C424, a low-frequency amplification loop C425, a low-pass amplification loop C426, a high-pass amplification loop C427, and a signal comparison loop C428.

The ultrasonic signal prevention and detection unit C5 which operates when the signal disappears is provided with an amplification loop C51, a detection loop C52, and a comparator loop C53, to output a signal level to the central processing unit C9 for discrimination, such that when the signal disappears, the signal can be outputted to the central processing unit C9 for discrimination.

The glass-fracture detection unit C6 which operates when a glass fractures is provided with a sensitivity adjusting loop C61, an amplification loop C62, a detection loop C63, and a comparator loop C64, such that when a car window fractures, a signal will be immediately outputted to the central processing unit C9 for discrimination; or when a thief uses a strong signal to interrupt, the glass-fracture detection unit C6 will also output the signal to the central processing unit C9 for discrimination.

The radio wave receiving unit C7 which operates to receive a radio wave signal of a key remote F is provided with a receiving antenna loop C71, a high-frequency amplification loop C72, a super-regenerative receiving loop C73, and a low-frequency signal amplification loop C74, to receive the radio wave signal sent out by the key remote F. The radio wave signal is processed, and is then outputted to the central processing unit C9 for program decoding, so as to facilitate that when the car owner enters into the car, he or she can remotely configure a delay to alarm first.

The vibration detection unit C8 which operates when the vibration sensor C2 detects a vibration situation is provided with a low-pass filter loop C81, a sensitivity adjusting loop C82, a low-frequency signal amplification loop C83, a positive and negative signal level discrimination and comparison loop C84, and an output loop C85, such that when the car vibrates abnormally, a signal can be outputted to the central processing unit C9 for discrimination.

By the detection end C1 and the vibration sensor C2, many kinds of possible situation which occur when the car is stolen, can be detected, thereby improving an automobile burglar-proof effect by the burglar-proof lockset A.

When the burglar-proof alarm circuit C starts to operate, it can drive the communication module D to dial a message that the burglar-proof system is started to a cellular phone number G preset by the car owner. Furthermore, when the burglar-proof alert message is created, the burglar-proof alarm circuit C will dial the preset telephone number through the communication module D to notify the car owner the burglar-proof alert signal. The communication module D is provided with a communication unit D1 which is connected to a set of chargeable battery D3 through a power switch D2, and the power switch D2 is controlled by the central processing unit C9 of the burglar-proof alarm circuit C, such that the burglar-proof alert signal of the burglar-proof lockset A can be transmitted to the car owner through the communication module D, which allows communication distance to be completely unlimited and reduces a dead angle of communication, thereby assuring the car owner to be aware of the burglar-proof alert state and to take a burglar-proof action in time.

In order to further manifest the advancement and the practicability of the present invention, the advantages thereof are listed below:
1. It can detect frequencies in multiple bands.
2. A quantity of the detection ends can be decreased.
3. Multiple kinds of factors that a car is stolen can be detected, and a detection effect can be improved.
4. Cost can be reduced.
5. A user can be notified immediately by the communication module.
6. It is provided with industrial competitiveness.
7. It is provided with value of business utilization.
8. It is provided with novelty.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A multi-functional burglar-proof lockset assembly structure, wherein the burglar-proof lockset includes a lockset, which is locked on a wheel ring of a steering wheel, and activates a function of burglar-proof alarm at a same time when the lockset is locked; a burglar-proof alarm circuit, which is contained in the lockset, is activated in corresponding to the locking of the lockset, and proceeds with a detection of a change of reflection wave frequency, a detection of abnormal fracture of a glass, and a prevention and detection of an ultrasonic signal, through a detection end and a central processing unit; and a communication module, which transmits a message to a preset receiving device when the burglar-proof alarm circuit activates and when the burglar-proof alarm circuit generates a burglar-proof alert message; through the burglar-proof alarm circuit that precisely detects and the detection end that detects bands in large range, and through the communication module, the message being transmitted to the preset receiving device in time, enabling the detection end to achieve a burglar-proof function with multiple alerts and a function of ultrasonic signal preventing and detecting, and allowing a user to take a necessary approach in time.

2. The multi-functional burglar-proof lockset assembly structure according to claim 1, wherein the burglar-proof alarm circuit includes further a vibration sensor for detecting a vibration state.

3. The multi-functional burglar-proof lockset assembly structure according to claim 1, wherein the lockset is provided with a locking body, a rod, a locking seat, and a locking sheath; when the locking sheath being locked on a wheel ring of a steering wheel and being locked on the locking seat, the burglar-proof alarm circuit being activated at a same time to proceed with a function of detecting and burglar-proofing.

4. The multi-functional burglar-proof lockset assembly structure according to claim 1, wherein the detection end is a mechanical capacitor, mechanical piezoelectric, and semi-conductor microphone device, enabling the burglar-proof alarm circuit to detect bands in large range.

5. The multi-functional burglar-proof lockset assembly structure according to claim 1, wherein the burglar-proof alarm circuit further includes a vibration sensor, and a vibration detection unit which is connected to the burglar-proof alarm circuit through the vibration sensor; the vibration detection unit being composed of a filter loop, a sensitivity adjusting loop, an amplification loop, a comparator loop, and an output loop, to output a signal to the central processing unit for discrimination.

6. The multi-functional burglar-proof lockset assembly structure according to claim 1, wherein the burglar-proof alarm circuit is provided with a barometric detection unit which operates by a signal of momentary change of atmospheric pressure; the barometric detection unit being composed of an atmospheric pressure signal amplification and sensitivity adjusting loop, and a comparison loop, to process a signal and then to transmit the processed signal to the central processing unit for discrimination, enabling the burglar-proof alarm circuit to effectively detect the momentary change of atmospheric pressure in a car.

7. The multi-functional burglar-proof lockset assembly structure according to claim 1, wherein the burglar-proof alarm circuit is provided with an ultrasonic detection unit which operates by a signal of object movement and which is composed of an ultrasonic emission part and an ultrasonic receiving part, to analyze and process a signal and to transmit the processed signal to the central processing unit for discrimination.

8. The multi-functional burglar-proof lockset assembly structure according to claim 7, wherein the ultrasonic emission part is provided with a high-frequency oscillation loop, a signal pushing loop, and an ultrasonic emitter, to send out an ultrasonic signal to a space in the car.

9. The multi-functional burglar-proof lockset assembly structure according to claim 7, wherein the ultrasonic receiving part is provided with an ultrasonic receiver, an amplification loop, a detection loop, a filter loop, a low-frequency amplification loop, a low-pass amplification loop, a high-pass amplification loop, and a signal comparison loop, to receive an ultrasonic signal, to proceed with analysis and processing, and to transmit the processed signal to the central processing unit for discrimination.

10. The multi-functional burglar-proof lockset assembly structure according to claim 1, wherein the burglar-proof alarm circuit is provided with a radio wave receiving unit which is composed of a receiving antenna loop, a high-frequency amplification loop, a super-regenerative receiving loop, and a low-frequency signal amplification loop, to receive a radio wave signal, to proceed with processing, and to output the processed signal to the central processing unit for discrimination.

11. The multi-functional burglar-proof lockset assembly structure according to claim 10, wherein the radio wave receiving unit receives a signal from a key remote, such that when a car owner enters into the car, he or she first remotely configures a delay to alarm.

12. The multi-functional burglar-proof lockset assembly structure according to claim 1, wherein the burglar-proof alarm circuit is provided with a prevention and detection unit which is composed of an amplification loop, a filter loop, and a comparator loop, such that when an ultrasonic detection signal disappears, an signal is outputted to the central processing unit for discrimination, thereby achieving a function of self loop-detection when the detection unit malfunctions or the signal disappears.

13. The multi-functional burglar-proof lockset assembly structure according to claim 1, wherein the burglar-proof alarm circuit is provided with a glass-fracture detection unit which is composed of a sensitivity adjusting loop, an amplification loop, a detection loop, and a comparator loop, to output a signal to the central processing unit for discrimination; when the alarm circuit being counter-measured or interrupted by a strong signal, a signal also being outputted to the central processing unit for discrimination.

14. The multi-functional burglar-proof lockset assembly structure according to claim 1, wherein the communication module is provided with a communication unit which is connected to a set of chargeable battery through a power switch, and the power switch is controlled by the central processing unit of the burglar-proof alarm circuit.
